(19) United States
(12) Patent Application Publication
(10) Pub. No.: US 2017/0008127 A1
(43) Pub. Date: Jan. 12, 2017

(54) Machine Tool System and Method for Additive Manufacturing

(71) Applicant: DMG MORI ADVANCED SOLUTIONS DEVELOPMENT, Hoffman Estates, IL (US)

(72) Inventors: Gregory A. Hyatt, South Barrington, IL (US); Nitin Chaphalkar, Schaumburg, IL (US); Karl Hranka, Chicago, IL (US); Michael J. Panzarella, Addison, IL (US)

(73) Assignee: DMG MORI ADVANCED SOLUTIONS DEVELOPMENT, Hoffman Estates, IL (US)

(21) Appl. No.: 15/119,331

(22) PCT Filed: Feb. 20, 2015
(86) PCT No.: PCT/US2015/016910

§ 371 Date: Aug. 16, 2016

Related U.S. Application Data
(60) Provisional application No. 61/942,453, filed on Feb. 20, 2014.

(51) Int. Cl. B23K 26/342; B23K 26/08; B23K 26/144; B23K 26/073; B33Y 10/00; B33Y 30/00

(52) U.S. Cl. CPC B23K 26/342; B33Y 10/00; B33Y 30/00; B23K 26/144; B23K 26/073; B23K 26/0869

(57) ABSTRACT

Methods and apparatus for performing additive manufacturing processes using a machine tool may include controlling an orientation of a processing head to control the tangential angle of a fabrication energy beam, a feed powder nozzle, or both. The orientation of a non-circular energy beam may be control to more evenly distribute the energy beam across a width of a tool path. Additionally or alternatively, the orientation of the feed powder nozzle may be controlled to project toward a powder target that is spaced from a beam target. The powder target may be directed to a trailing edge of a beam spot formed by the energy beam to increase the amount of powder incorporated into a melt pool formed by the energy beam. Alternatively, the powder target may be directed to a leading edge of the beam spot to provide a self-correcting feature to address thickness errors formed in previous layers of added material.

### BACKGROUND

Technical Field

The present disclosure generally relates to computed numerically controlled machine tools, and more particularly, to methods and apparatus for performing additive manufacturing with machine tools.

Description of the Related Art

Traditionally, materials are processed into desired shapes and assemblies through a combination of rough fabrication techniques (e.g., casting, rolling, forging, extrusion, and stamping) and finish fabrication techniques (e.g., machining, welding, soldering, polishing). To produce a complex assembly in final, usable form (“net shape”), a condition which requires not only the proper materials formed in the proper shapes, but also having the proper combination of metallurgical properties (e.g., various heat treatments, work hardening, complex microstructure), typically requires considerable investment in time, tools, and effort.

One or more of the rough and finish processes may be performed using Computer Numerically Controlled (CNC) machine tools. Such machine tools include lathes, milling machines, grinding machines, and other tool types. More recently, machining centers have been developed, which provide a single machine having multiple tool types and capable of performing multiple different machining processes. Machining centers may generally include one or more tool retainers, such as spindle retainers and turret retainers holding one or more tools, and a workpiece retainer, such as a pair of chucks. The workpiece retainer may be stationary or move (in translation and/or rotation) while a tool is brought into contact with the workpiece, thereby performing a subtractive manufacturing process during which material is removed from the workpiece.

Because of cost, expense, complexity, and other factors, more recently there has been interest in alternative techniques which would allow part or all of the conventional materials fabrication procedures to be replaced by additive manufacturing techniques. In contrast to subtractive manufacturing processes, which focus on precise removal of material from a workpiece, additive manufacturing processes precisely add material, typically in a computer-controlled environment. While additive manufacturing techniques may improve efficiency and reduce waste, they may also expand manufacturing capabilities such as by permitting seamless construction of complex configurations which, using conventional manufacturing techniques, would have to be assembled from a plurality of component parts. For the purposes of this specification and the appended claims, the term ‘plurality’ consistently is taken to mean “two or more.” The opportunity for additive techniques to replace subtractive processes depends on several factors, such as the range of materials available for use in the additive processes, the size and surface finish that can be achieved using additive techniques, and the rate at which material can be added. Additive processes may advantageously be capable of fabricating complex precision net-shape components ready for use. In some cases, however, the additive process may generate “near-net shape” products that require some degree of finishing.

In general, additive and subtractive processing techniques have developed substantially independently, and therefore have overlooked synergies that may result from combining these two distinct types of processes and the apparatus for performing them.

### SUMMARY OF THE DISCLOSURE

In accordance with one aspect of the present disclosure, a method of depositing material on a substrate using a machine tool for use with a fabrication energy supply and a feed powder/propellant supply is provided that includes securing a substrate in a first tool holder, and securing a processing head assembly in a second tool holder, the processing head assembly including a nozzle defining a fabrication energy outlet operably coupled to the fabrication energy supply and having a non-circular shape, and a nozzle exit operably coupled to the feed powder/propellant supply. A fabrication energy beam is projected from the fabrication energy outlet onto the substrate to form an energy spot at a target area of the substrate, a profile of the energy spot having a non-circular shape corresponding to the non-circular shape of the fabrication energy outlet, and feed powder/propellant is projected from the nozzle exit onto the target area of the substrate. The method further includes causing relative movement between the first and second tool holders so that the energy spot traverses a tool path along the substrate, wherein movement of the energy spot defines a spot orientation vector extending in an instantaneous direction of travel of the energy spot, and wherein the tool path defines a tool path vector extending at a tangent to the tool path. An orientation of the second tool holder is controlled based on an orientation of the spot orientation vector relative to the tool path vector.

In accordance with another aspect of the disclosure, a machine tool is provided for use with a feed powder/propellant supply and a fabrication energy supply. The machine tool includes a first tool holder carrying a substrate, a second tool holder, and a processing head assembly coupled to the second tool holder and including a feed powder/propellant interface operably coupled to the feed powder/propellant supply, a fabrication energy interface operably coupled to the fabrication energy supply, a fabrication energy outlet operably coupled to the fabrication energy interface, the fabrication energy outlet having a non-circular shape, and a nozzle defining a nozzle exit fluidly communicating with the feed powder/propellant interface. Machine control circuitry is operatively coupled to the first tool holder and the second tool holder, the machine control circuitry comprising one or more central processing units and one or more memory devices, the one or more memory devices storing instructions that, when executed by the one or more central processing units, cause the machine control circuitry to position the first and second tool holders to direct a fabrication energy beam from the fabrication energy outlet onto the substrate to form an energy spot at a target area of the substrate, the energy spot having a profile that is non-circular, and to direct feed powder/propellant from the nozzle exit onto the target area of the substrate, cause relative movement between the first and second tool holders so that the energy spot traverses a tool path along the substrate, wherein movement of the energy spot defines a spot orientation vector extending in an instantaneous direction of travel of the energy spot, and wherein the tool path defines a tool path vector extending at a tangent to the tool path, and control an orientation of the second tool holder based on an orientation of the spot orientation vector relative to the tool path vector.

In accordance with another aspect of the present disclosure, which may be combined with one or more of the other aspects identified herein, controlling the orientation of the second tool holder comprises orienting the second tool holder so that the spot orientation vector extends at a spot angle relative to the tool path vector.

In accordance with another aspect of the present disclosure, which may be combined with one or more of the other aspects identified herein, the spot angle is zero.

In accordance with another aspect of the present disclosure, which may be combined with one or more of the other aspects identified herein, the spot angle is greater than zero.

In accordance with another aspect of the present disclosure, which may be combined with one or more of the other aspects identified herein, the spot angle is constant along the tool path.

In accordance with another aspect of the present disclosure, which may be combined with one or more of the other aspects identified herein, the spot angle varies along the tool path.

In accordance with another aspect of the present disclosure, which may be combined with one or more of the other aspects identified herein, a method of depositing material on a substrate using a machine tool for use with a fabrication energy supply and a feed powder/propellant supply is provided that includes securing a substrate in a first tool holder, securing a processing head assembly in a second tool holder, the processing head assembly including a nozzle defining a fabrication energy outlet operably coupled to the fabrication energy supply, and a nozzle exit operably coupled to the feed powder/propellant supply, projecting a fabrication energy beam from the fabrication energy outlet onto the substrate to form an energy spot at a beam target on the substrate, projecting feed powder/propellant from the nozzle exit toward a powder target on the substrate, wherein the powder target is spaced by an offset distance from the beam target, causing relative movement between the first and second tool holders so that the energy spot traverses in a travel direction along a tool path across the substrate, and controlling an orientation of the second tool holder to maintain the offset distance between the beam target and the powder target as the energy spot traverses the tool path.

In accordance with another aspect of the present disclosure, which may be combined with one or more of the other aspects identified herein, a machine tool is provided for use with a feed powder/propellant supply and a fabrication energy supply. The machine tool includes a first tool holder carrying a substrate, a second tool holder, and a processing head assembly coupled to the second tool holder and including a feed powder/propellant interface operably coupled to the feed powder/propellant supply, a fabrication energy interface operably coupled to the fabrication energy supply, a fabrication energy outlet operably coupled to the fabrication energy interface, and a nozzle defining a nozzle exit fluidly communicating with the feed powder/propellant interface. Machine control circuitry is operatively coupled to the first tool holder and the second tool holder, the machine control circuitry comprising one or more central processing units and one or more memory devices, the one or more memory devices storing instructions that, when executed by the one or more central processing units, cause the machine control circuitry to position the first and second tool holders to direct a fabrication energy beam from the fabrication energy outlet onto the substrate to form an energy spot at a beam target on the substrate, and to direct feed powder/propellant from the nozzle exit toward a powder target on the substrate, wherein the powder target is spaced by an offset distance from the beam target, cause relative movement between the first and second tool holders so that the energy spot traverses a tool path in a travel direction across the substrate, and control an orientation of the second tool holder to maintain the offset distance between the beam target and the powder target as the energy spot traverses the tool path.

In accordance with another aspect of the present disclosure, which may be combined with one or more of the other aspects identified herein, the energy spot defines a trailing edge relative to the travel direction, and in which the powder target is coincident with the trailing edge of the energy spot.

In accordance with another aspect of the present disclosure, which may be combined with one or more of the other aspects identified herein, the energy spot defines a leading edge relative to the travel direction, and in which the powder target is coincident with the leading edge of the energy spot.

In accordance with another aspect of the present disclosure, which may be combined with one or more of the other aspects identified herein, the energy target is disposed along a beam axis, and the powder target is disposed along a powder axis extending at an angle to the beam axis.

### BRIEF DESCRIPTION OF THE DRAWINGS

For a more complete understanding of the disclosed methods and apparatus, reference should be made to the embodiment illustrated in greater detail on the accompanying drawings, wherein:

FIG. 1 is a front elevation of a computer numerically controlled machine in accordance with one embodiment of the present disclosure, shown with safety doors closed.

FIG. 2 is a front elevation of a computer numerically controlled machine illustrated in FIG. 1, shown with the safety doors open.

FIG. 3 is a perspective view of certain interior components of the computer numerically controlled machine illustrated in FIGS. 1 and 2, depicting a machining spindle, a first chuck, a second chuck, and a turret.

FIG. 4 a perspective view, enlarged with respect to FIG. 3 illustrating the machining spindle and the horizontally and vertically disposed rails via which the spindle may be translated.

FIG. 5 is a side view of the first chuck, machining spindle, and turret of the machining center illustrated in FIG. 1.

FIG. 6 is a view similar to FIG. 5 but in which a machining spindle has been translated in the Y-axis.

FIG. 7 is a front view of the spindle, first chuck, and second chuck of the computer numerically controlled machine illustrated in FIG. 1, including a line depicting the permitted path of rotational movement of this spindle.

FIG. 8 is a perspective view of the second chuck illustrated in FIG. 3, enlarged with respect to FIG. 3.

FIG. 9 is a perspective view of the first chuck and turret illustrated in FIG. 2, depicting movement of the turret and turret stock in the Z-axis relative to the position of the turret in FIG. 2.

FIG. 10 is a front view of the computer numerically controlled machine of FIG. 1 with the front doors open.

FIG. 11 is a schematic illustration of a material deposition assembly for use with the computer numerically controlled machine of FIG. 1.

FIG. 12 is a side elevation view of a material deposition assembly having a removable deposition head.

FIG. 13 is a side elevation view of an alternative embodiment of a material deposition assembly having a removable deposition head.

FIG. 14 is a side elevation view, in partial cross-section, of a lower processing head used in the material deposition assembly of FIG. 12.

FIG. 15 is a schematic illustration of a conventional and modified energy beams and a graphical depiction of their related exposure times across a width of a tool path.

FIG. 16 is a schematic illustration of a modified energy beam traversing an irregular tool path.

FIG. 17 is a schematic illustration of a modified energy beam traversing an irregular tool path to form a complete pattern layer.

FIG. 18 is a perspective view of a three-dimensional object formed by multiple pattern layers shown in FIG. 17.

FIGS. 19(a)-(c) are schematic illustrations of modified energy beams having a spot vectors extending at angles relative to associated tool path vectors.

FIGS. 20(a)-(h) are schematic illustrations showing alternative embodiments of nozzles having rectangular-shaped fabrication energy outlets with different configurations of nozzle exits.

FIG. 21 is a schematic illustration of an alternative embodiment in which feed powder/propellant is directed to a trailing edge of an energy spot.

FIG. 22 is a graphical illustration showing a temperature of a point on a substrate as an energy spot passes.

FIG. 23 is an enlarged schematic illustration of the energy spot, melt pool, and powder target of the embodiment of FIG. 21.

FIGS. 24(a)-(c) are schematic illustrations of yet another embodiment in which feed powder/propellant are directed toward a leading edge of an energy spot.

It should be understood that the drawings are not necessarily to scale and that the disclosed embodiments are sometimes illustrated diagrammatically and in partial views. In certain instances, details which are not necessary for an understanding of the disclosed methods and apparatus or which render other details difficult to perceive may have been omitted. It should be understood, of course, that this disclosure is not limited to the particular embodiments illustrated herein.

### DETAILED DESCRIPTION

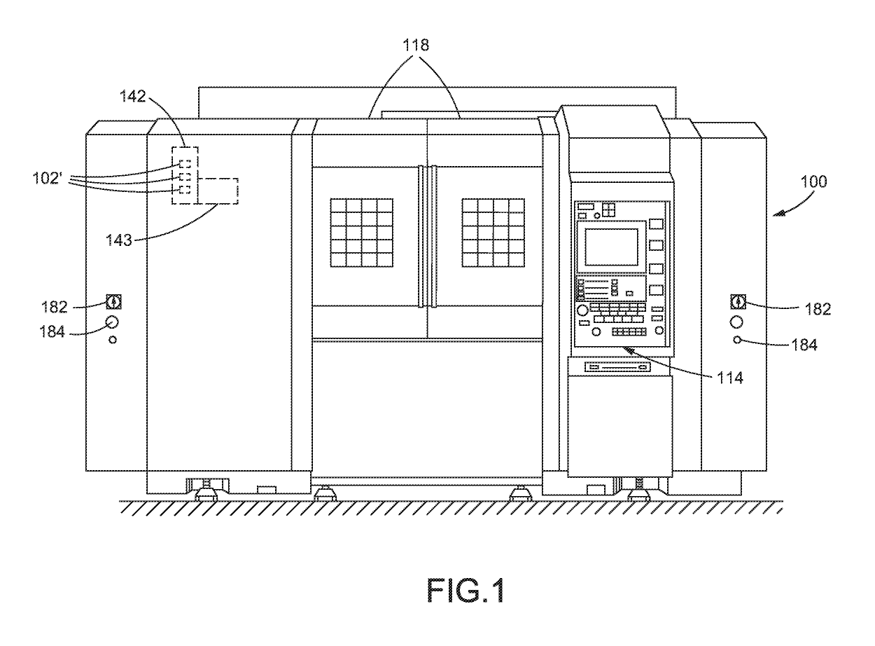

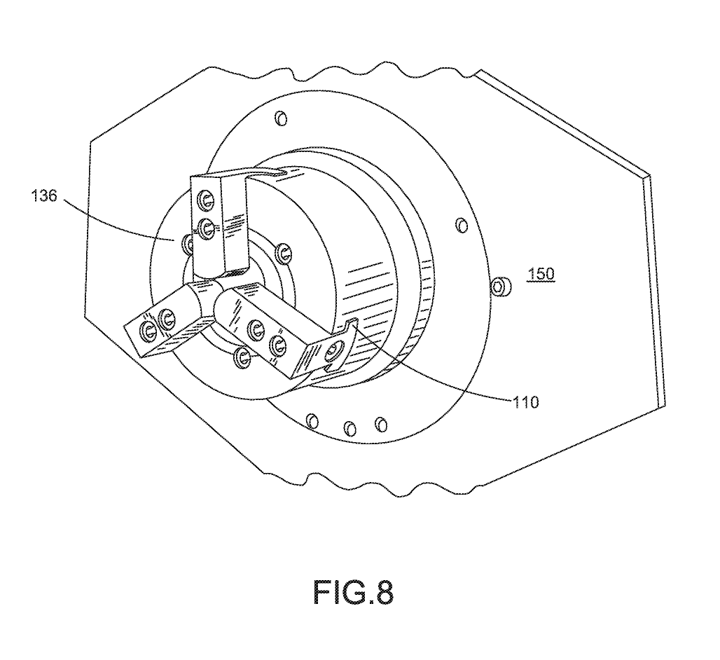

Any suitable apparatus may be employed in conjunction with the methods disclosed herein. In some embodiments, the methods are performed using a computer numerically controlled machine, illustrated generally in FIGS. 1-10. A computer numerically controlled machine is itself provided in other embodiments. The machine 100 illustrated in FIGS. 1-10 is an NT-series machine, versions of which are available from DMG/Mori Seiki USA, the assignee of the present application. Alternatively, DMG/Mori Seiki's DMU-65 (a five-axis, vertical machine tool) machine tool, or other machine tools having different orientations or numbers of axes, may be used in conjunction with the apparatus and methods disclosed herein.

In general, with reference to the NT-series machine illustrated in FIGS. 1-3, one suitable computer numerically controlled machine 100 has at least a first retainer and a second retainer, each of which may be a tool retainer (such as a spindle retainer associated with spindle 144 or a turret retainer associated with a turret 108) or a workpiece retainer (such as chucks 110, 112). In the embodiment illustrated in the Figures, the computer numerically controlled machine 100 is provided with a spindle 144, a turret 108, a first chuck 110, and a second chuck 112. The computer numerically controlled machine 100 also has a computer control system operatively coupled to the first retainer and to the second retainer for controlling the retainers, as described in more detail below. It is understood that in some embodiments, the computer numerically controlled machine 100 may not contain all of the above components, and in other embodiments, the computer numerically controlled machine 100 may contain additional components beyond those designated herein.

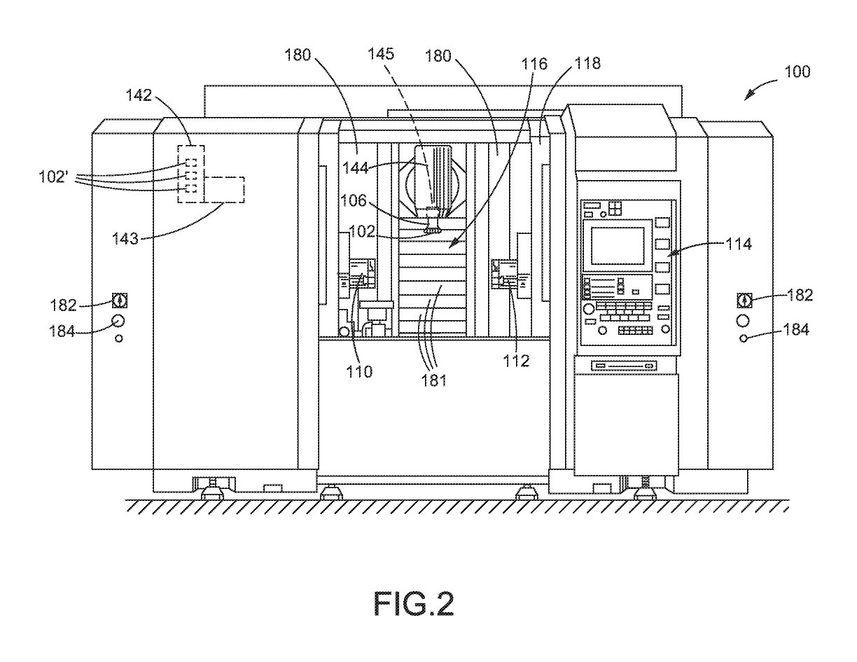

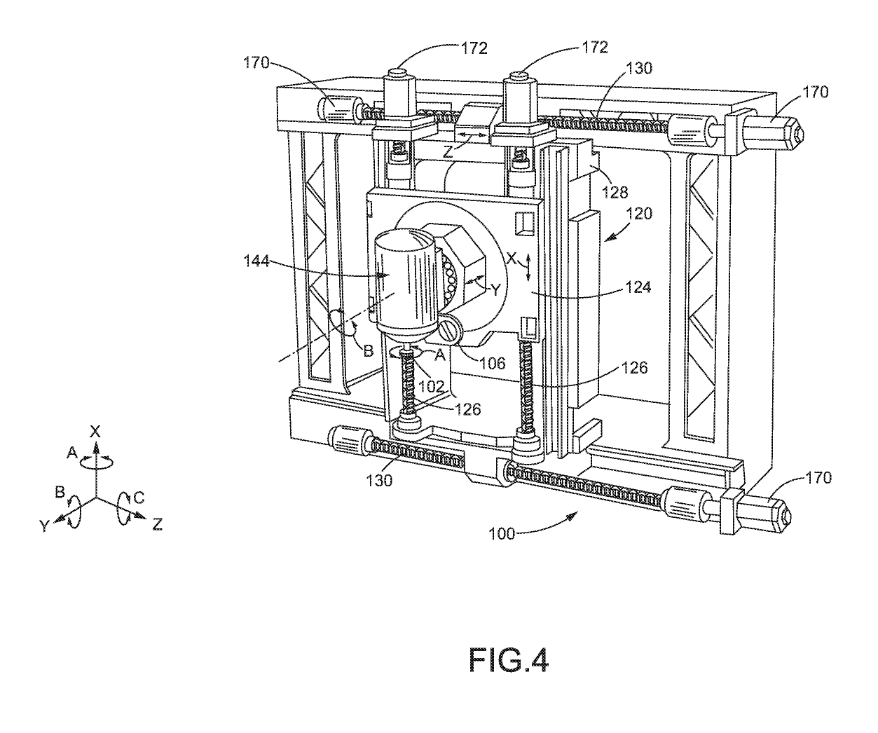

As shown in FIGS. 1 and 2, the computer numerically controlled machine 100 has a machine chamber 116 in which various operations generally take place upon a workpiece (not shown). Each of the spindle 144, the turret 108, the first chuck 110, and the second chuck 112 may be completely or partially located within the machine chamber 116. In the embodiment shown, two moveable safety doors 118 separate the user from the machine chamber 116 to prevent injury to the user or interference in the operation of the computer numerically controlled machine 100. The safety doors 118 can be opened to permit access to the machine chamber 116 as illustrated in FIG. 2. The computer numerically controlled machine 100 is described herein with respect to three orthogonally oriented linear axes (X, Y, and Z), depicted in FIG. 4 and described in greater detail below. Rotational axes about the X, Y and Z axes are connoted “A,” “B,” and “C” rotational axes respectively.

The computer numerically controlled machine 100 is provided with a computer control system for controlling the various instrumentalities within the computer numerically controlled machine. In the illustrated embodiment, the machine is provided with two interlinked computer systems, a first computer system comprising a user interface system (shown generally at 114 in FIG. 1) and a second computer system (not illustrated) operatively connected to the first computer system. The second computer system directly controls the operations of the spindle, the turret, and the other instrumentalities of the machine, while the user interface system 114 allows an operator to control the second computer system. Collectively, the machine control system and the user interface system, together with the various mechanisms for control of operations in the machine, may be considered a single computer control system.

The computer control system may include machine control circuitry having a central processing unit (CPU) connected to a main memory. The CPU may include any suitable processor(s), such as those made by Intel and AMD. By way of example, the CPU may include a plurality of microprocessors including a master processor, a slave processor, and a secondary or parallel processor. Machine control circuitry, as used herein, comprises any combination of hardware, software, or firmware disposed in or outside of the machine 100 that is configured to communicate with or control the transfer of data between the machine 100 and a bus, another computer, processor, device, service, or network. The machine control circuitry, and more specifically the CPU, comprises one or more controllers or processors and such one or more controllers or processors need not be disposed proximal to one another and may be located in different devices or in different locations. The machine control circuitry, and more specifically the main memory, comprises one or more memory devices which need not be disposed proximal to one another and may be located in different devices or in different locations. The machine control circuitry is operable to execute all of the various machine tool methods and other processes disclosed herein.

In some embodiments, the user operates the user interface system to impart programming to the machine; in other embodiments, programs can be loaded or transferred into the machine via external sources. It is contemplated, for instance, that programs may be loaded via a PCMCIA interface, an RS-232 interface, a universal serial bus interface (USB), or a network interface, in particular a TCP/IP network interface. In other embodiments, a machine may be controlled via conventional PLC (programmable logic controller) mechanisms (not illustrated).

As further illustrated in FIGS. 1 and 2, the computer numerically controlled machine 100 may have a tool magazine 142 and a tool changer 143. These cooperate with the spindle 144 to permit the spindle to operate with any one of multiple tools. Generally, a variety of tools may be provided; in some embodiments, multiple tools of the same type may be provided.

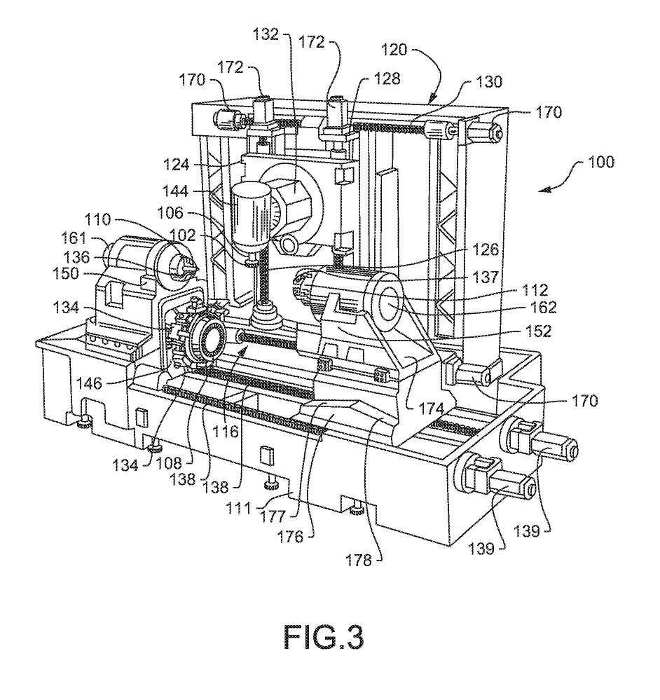

The spindle 144 is mounted on a carriage assembly 120 that allows for translational movement along the X- and Z-axis, and on a ram 132 that allows the spindle 144 to be moved in the Y-axis. The ram 132 is equipped with a motor to allow rotation of the spindle in the B-axis, as set forth in more detail below. As illustrated, the carriage assembly has a first carriage 124 that rides along two threaded vertical rails (one rail shown at 126) to cause the first carriage 124 and spindle 144 to translate in the X-axis. The carriage assembly also includes a second carriage 128 that rides along two horizontally disposed threaded rails (one shown in FIG. 3 at 130) to allow movement of the second carriage 128 and spindle 144 in the Z-axis. Each carriage 124, 128 engages the rails via plural ball screw devices whereby rotation of the rails 126, 130 causes translation of the carriage in the X- or Z-direction respectively. The rails are equipped with motors 170 and 172 for the horizontally disposed and vertically disposed rails respectively.

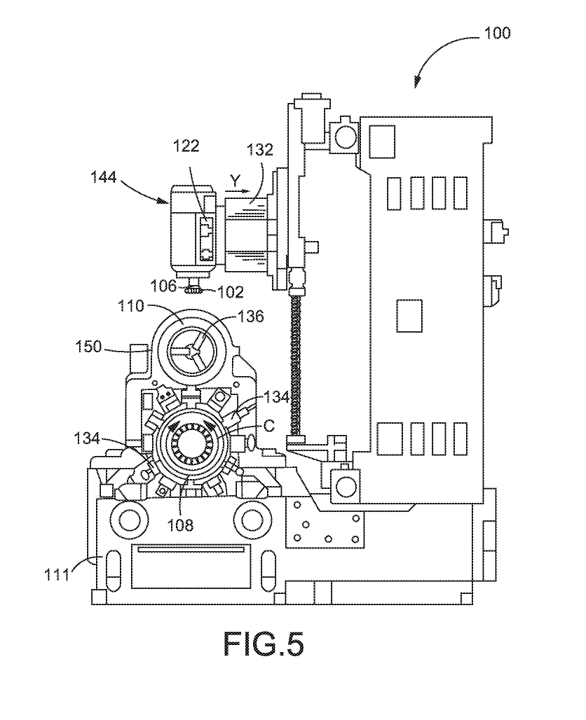

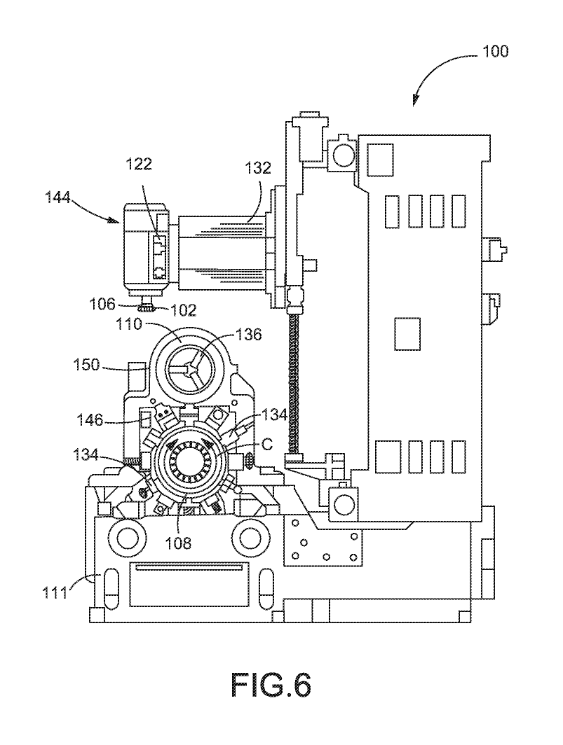

The spindle 144 holds the tool 102 by way of a spindle connection and a tool retainer 106. The spindle connection 145 (shown in FIG. 2) is connected to the spindle 144 and is contained within the spindle 144. The tool retainer 106 is connected to the spindle connection and holds the tool 102. Various types of spindle connections are known in the art and can be used with the computer numerically controlled machine 100. Typically, the spindle connection is contained within the spindle 144 for the life of the spindle. An access plate 122 for the spindle 144 is shown in FIGS. 5 and 6.

The first chuck 110 is provided with jaws 136 and is disposed in a stock 150 that is stationary with respect to the base 111 of the computer numerically controlled machine 100. The second chuck 112 is also provided with jaws 137, but the second chuck 112 is movable with respect to the base 111 of the computer numerically controlled machine 100. More specifically, the machine 100 is provided with threaded rails 138 and motors 139 for causing translation in the Z-direction of the second stock 152 via a ball screw mechanism as heretofore described. To assist in swarf removal, the stock 152 is provided with a sloped distal surface 174 and a side frame 176 with Z-sloped surfaces 177, 178. Hydraulic controls and associated indicators for the chucks 110, 112 may be provided, such as the pressure gauges 182 and control knobs 184 shown in FIGS. 1 and 2. Each stock is provided with a motor (161, 162 respectively) for causing rotation of the chuck.

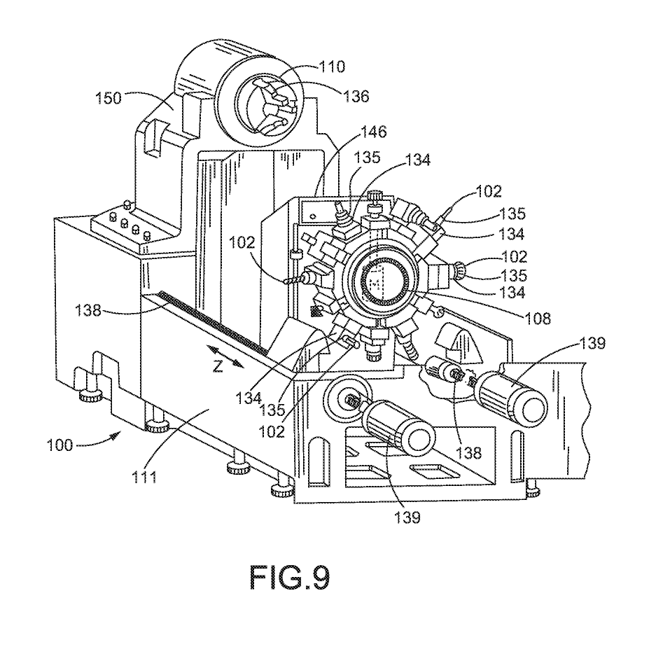

The turret 108, which is best depicted in FIGS. 5, 6 and 9, is mounted in a turret stock 146 (FIG. 5) that also engages rails 138 and that may be translated in a Z-direction, again via ball-screw devices. The turret 108 is provided with various turret connectors 134, as illustrated in FIG. 9. Each turret connector 134 can be connected to a tool retainer 135 or other connection for connecting to a tool. Since the turret 108 can have a variety of turret connectors 134 and tool retainers 135, a variety of different tools can be held and operated by the turret 108. The turret 108 may be rotated in a C′ axis to present different ones of the tool retainers (and hence, in many embodiments, different tools) to a workpiece.

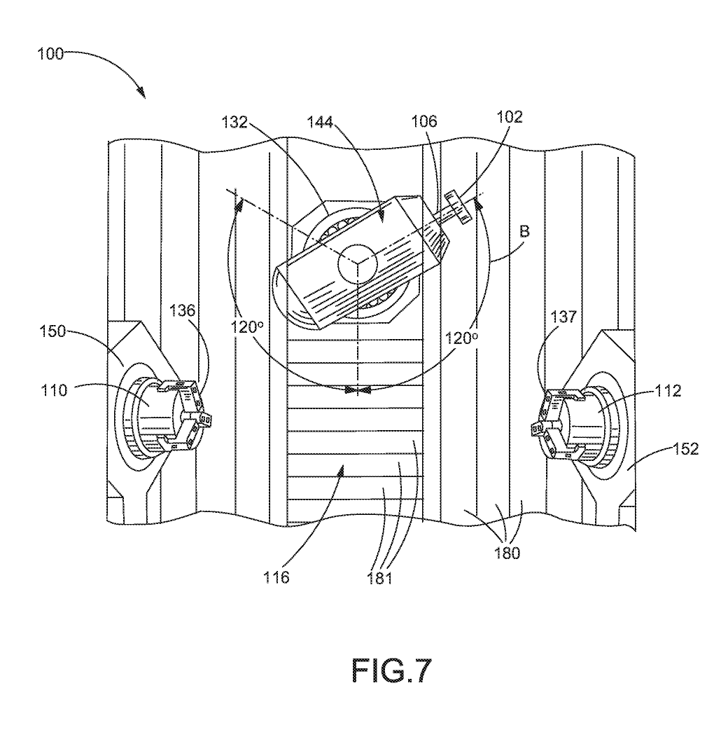

It is thus seen that a wide range of versatile operations may be performed. With reference to tool 102 held in tool retainer 106, such tool 102 may be brought to bear against a workpiece (not shown) held by one or both of chucks 110, 112. When it is necessary or desirable to change the tool 102, a replacement tool 102 may be retrieved from the tool magazine 142 by means of the tool changer 143. With reference to FIGS. 4 and 5, the spindle 144 may be translated in the X and Z directions (shown in FIG. 4) and Y direction (shown in FIGS. 5 and 6). Rotation in the B axis is depicted in FIG. 7, the illustrated embodiment permitting rotation within a range of 120 degrees to either side of the vertical. Movement in the Y direction and rotation in the B axis are powered by motors (not shown) that are located behind the carriage 124.

Generally, as seen in FIGS. 2 and 7, the machine is provided with a plurality of vertically disposed leaves 180 and horizontal disposed leaves 181 to define a wall of the machine chamber 116 and to prevent swarf from exiting this chamber.

The components of the machine 100 are not limited to the heretofore described components. For instance, in some instances an additional turret may be provided. In other instances, additional chucks and/or spindles may be provided. Generally, the machine is provided with one or more mechanisms for introducing a cooling liquid into the machine chamber 116.

In the illustrated embodiment, the computer numerically controlled machine 100 is provided with numerous retainers. Chuck 110 in combination with jaws 136 forms a retainer, as does chuck 112 in combination with jaws 137. In many instances these retainers will also be used to hold a workpiece. For instance, the chucks and associated stocks will function in a lathe-like manner as the headstock and optional tailstock for a rotating workpiece. Spindle 144 and spindle connection 145 form another retainer. Similarly, the turret 108, when equipped with plural turret connectors 134, provides a plurality of retainers (shown in FIG. 9).

The computer numerically controlled machine 100 may use any of a number of different types of tools known in the art or otherwise found to be suitable. For instance, the tool 102 may be a cutting tool such as a milling tool, a drilling tool, a grinding tool, a blade tool, a broaching tool, a turning tool, or any other type of cutting tool deemed appropriate in connection with a computer numerically controlled machine 100. Additionally or alternatively, the tool may be configured for an additive manufacturing technique, as discussed in greater detail below. In either case, the computer numerically controlled machine 100 may be provided with more than one type of tool, and via the mechanisms of the tool changer 143 and magazine 142, the spindle 144 may be caused to exchange one tool for another. Similarly, the turret 108 may be provided with one or more tools 102, and the operator may switch between tools 102 by causing rotation of the turret 108 to bring a new turret connector 134 into the appropriate position.

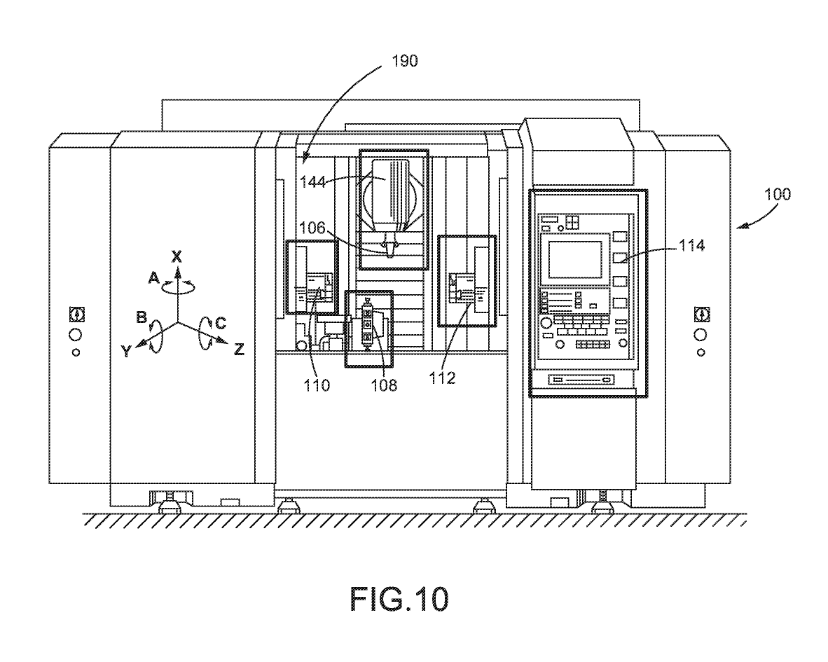

The computer numerically controlled machine 100 is illustrated in FIG. 10 with the safety doors open. As shown, the computer numerically controlled machine 100 may be provided with at least a tool retainer 106 disposed on a spindle 144, a turret 108, one or more chucks or workpiece retainers 110, 112 as well as a user interface 114 configured to interface with a computer control system of the computer numerically controlled machine 100. Each of the tool retainer 106, spindle 144, turret 108 and workpiece retainers 110, 112 may be disposed within a machining area 190 and selectively rotatable and/or movable relative to one another along one or more of a variety of axes.

As indicated in FIG. 10, for example, the X, Y, and Z axes may indicate orthogonal directions of movement, while the A, B, and C axes may indicate rotational directions about the X, Y, and Z axes, respectively. These axes are provided to help describe movement in a three-dimensional space, and therefore, other coordinate schemes may be used without departing from the scope of the appended claims. Additionally, use of these axes to describe movement is intended to encompass actual, physical axes that are perpendicular to one another, as well as virtual axes that may not be physically perpendicular but in which the tool path is manipulated by a controller to behave as if they were physically perpendicular.

With reference to the axes shown in FIG. 10, the tool retainer 106 may be rotated about a B-axis of the spindle 144 upon which it is supported, while the spindle 144 itself may be movable along an X-axis, a Y-axis and a Z-axis. The turret 108 may be movable along an XA-axis substantially parallel to the X-axis and a ZA-axis substantially parallel to the Z axis. The workpiece retainers 110, 112 may be rotatable about a C-axis, and further, independently translatable along one or more axes relative to the machining area 190. While the computer numerically controlled machine 100 is shown as a six-axis machine, it is understood that the number of axes of movement is merely exemplary, as the machine may be capable of movement in less than or greater than six axes without departing from the scope of the claims.

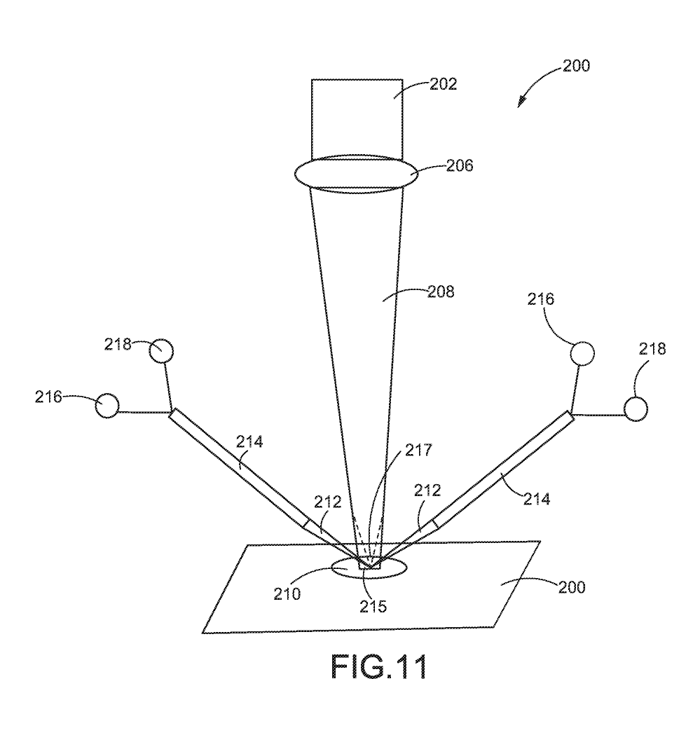

The computer numerically controlled machine 100 may include a material deposition assembly for performing additive manufacturing processes. An exemplary material deposition assembly 200 is schematically illustrated in FIG. 11 as including an energy beam 202 capable of being directed toward a substrate 204. The substrate 204 may be supported by one or more of the workpiece retainers, such as chucks 110, 112. The material deposition assembly 200 may further include an optic 206 that may direct a concentrated energy beam 208 toward the substrate 204, however the optic 206 may be omitted if the energy beam 202 has sufficiently large energy density. The energy beam 202 may be a laser beam, an electron beam, an ion beam, a cluster beam, a neutral particle beam, a plasma jet, or a simple electrical discharge (arc). The concentrated energy beam 208 may have an energy density sufficient to melt a small portion of the growth surface substrate 204, thereby forming a melt-pool 210, without losing substrate material due to evaporation, splattering, erosion, shock-wave interactions, or other dynamic effects. The concentrated energy beam 208 may be continuous or intermittently pulsed.

The melt-pool 210 may include liquefied material from the substrate 204 as well as added feed material. Feed material may be provided as a feed powder that is directed onto the melt-pool 210 in a feed powder/propellant gas mixture 212 exiting one or more nozzles 214. The nozzles 214 may fluidly communicate with a feed powder reservoir 216 and a propellant gas reservoir 218. The nozzles 214 create a flow pattern of feed powder/propellant gas mixture 212 that may substantially converge into an apex 215, or region of smallest physical cross-section so that the feed powder is incorporated into the melt-pool 210. As the material deposition assembly 200 is moved relative to the substrate 204, the assembly traverses a tool path that forms a bead layer on the substrate 204. Additional bead layers may be formed adjacent to or on top of the initial bead layer to fabricate solid, three-dimensional objects.

Depending on the materials used and the object tolerances required, it is often possible to form net shape objects, or objects which do not require further machining for their intended application (polishing and the like are permitted). Should the required tolerances be more precise than are obtainable by the material deposition assembly 200, a subtractive finishing process may be used. When additional finishing machining is needed, the object generated by the deposition assembly 200 prior to such finishing is referred to herein as “near-net shape” to indicate that little material or machining is needed to complete the fabrication process.

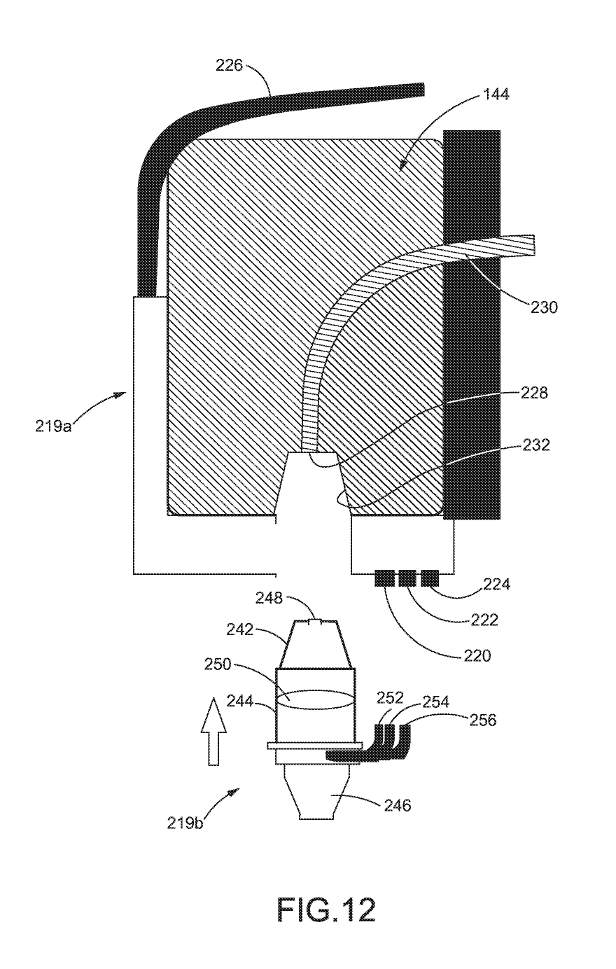

The material deposition assembly 200 may be incorporated into the computer numerically controlled machine 100, as best shown in FIG. 12. In this exemplary embodiment, the material deposition assembly 200 includes a processing head assembly 219 having an upper processing head 219a and a lower processing head 219b. The lower processing head 219b may be detachably coupled to the upper processing head 219a to permit the upper processing head 219a to be used with different lower processing heads 219b. The ability to change the lower processing head 219b may be advantageous when different deposition characteristics are desired, such as when different shapes and/or densities of the fabrication energy beam 202 and/or feed powder/propellant gas mixture 212 are needed.

More specifically, the upper processing head 219a may include the spindle 144. A plurality of ports may be coupled to the spindle 144 and are configured to interface with the lower processing head 219b when connected. For example, the spindle 144 may carry a feed powder/propellant port 220 fluidly communicating with a powder feed supply (not shown), which may include a feed powder reservoir and a propellant reservoir. Additionally, the spindle 144 may carry a shield gas port 222 fluidly communicating with a shield gas supply (not shown), and a coolant port 224 fluidly communicating with a coolant supply (not shown). The feed powder/propellant port 220, shield gas port 222, and coolant port 224 may be connected to their respective supplies either individually or through a harnessed set of conduits, such as conduit assembly 226.

The upper processing head 219a further may include a fabrication energy port 228 operatively coupled to a fabrication energy supply (not shown). In the illustrated embodiment, the fabrication energy supply is a laser connected to the fabrication energy port 228 by laser fiber 230 extending through a housing of the spindle 144. The laser fiber 230 may travel through a body of the spindle 144, in which case the fabrication energy port 228 may be located in a socket 232 formed in a bottom of the spindle 144. Therefore, in the embodiment of FIG. 12, the fabrication energy port 228 is disposed inside the socket 232 while the feed powder/propellant port 220, shield gas port 222, and coolant port 224 are disposed adjacent the socket 232. The upper processing head 219a may further include additional optics for shaping the energy beam, such as a collimation lens, a partially reflective mirror, or a curved mirror.

The upper processing head 219a may be selectively coupled to one of a plurality of lower processing heads 219b. As shown in FIG. 12, an exemplary lower processing head 219b may generally include a base 242, an optic chamber 244, and a nozzle 246. Additionally, a nozzle adjustment assembly may be provided to translate, rotate, or otherwise adjust the position and/or orientation of the nozzle 246 relative to the energy beam. The base 242 is configured to closely fit inside the socket 232 to permit releasable engagement between the lower processing head 219b and the upper processing head 219a. In the embodiment of FIG. 12, the base 242 also includes a fabrication energy interface 248 configured to detachably couple to the fabrication energy port 228. The optic chamber 244 may be either empty or it may include a final optic device, such as a focusing optic 250 configured to provide the desired concentrated energy beam. The lower processing head 219b may further include a feed powder/propellant interface 252, a shield gas interface 254, and a coolant interface 256 configured to operatively couple with the feed powder/propellant port 220, shield gas port 222, and coolant port 224, respectively.

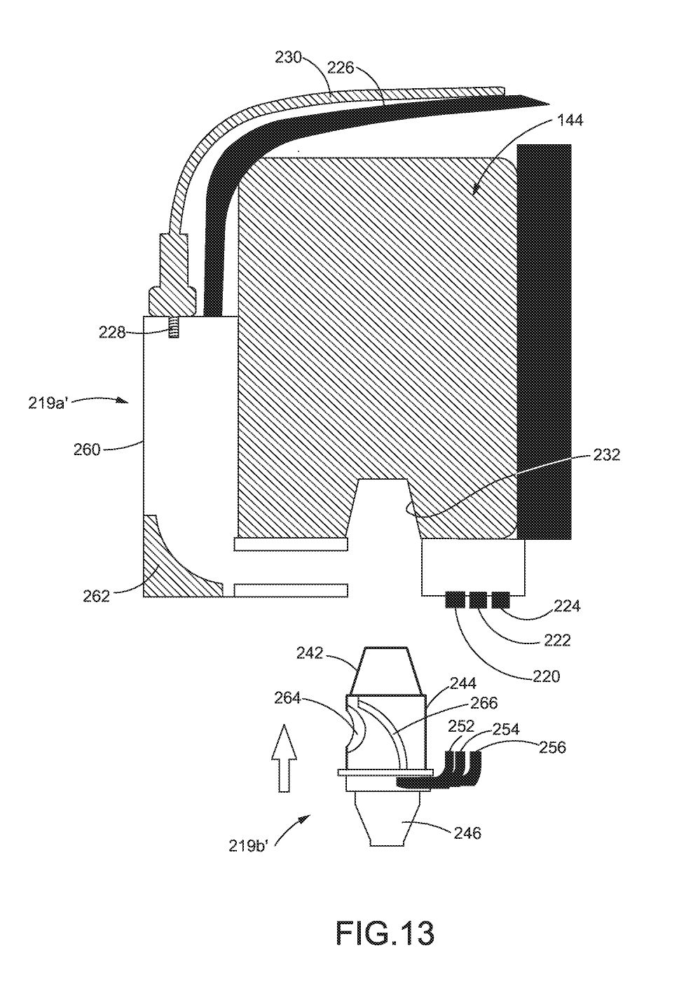

The nozzle 246 may be configured to direct feed powder/propellant toward the desired target area. In the embodiment illustrated at FIG. 13, the nozzle 246 includes an outer nozzle wall 270 spaced from an inner nozzle wall 272 to define a powder/propellant chamber 274 in the space between the outer and inner nozzle walls 270, 272. The powder/propellant chamber 274 fluidly communicates with the feed powder/propellant interface 252 at one end and terminates at an opposite end in a nozzle exit orifice 276. In the exemplary embodiment, the nozzle exit orifice 276 has an annular shape, however other the nozzle exit orifice 276 may have other shapes without departing from the scope of the present disclosure. The powder/propellant chamber 274 and nozzle exit orifice 276 may be configured to provide one or more jets of feed powder/propellant at the desired angle of convergence. The nozzle 246 of the illustrated embodiment may deliver a single, conical-shaped jet of powder/propellant gas. It will be appreciated, however, that the nozzle exit orifice 276 may be configured to provide multiple discrete jets of powder/propellant gas. Still further, the resulting jet(s) of powder/propellant gas may have shapes other than conical.

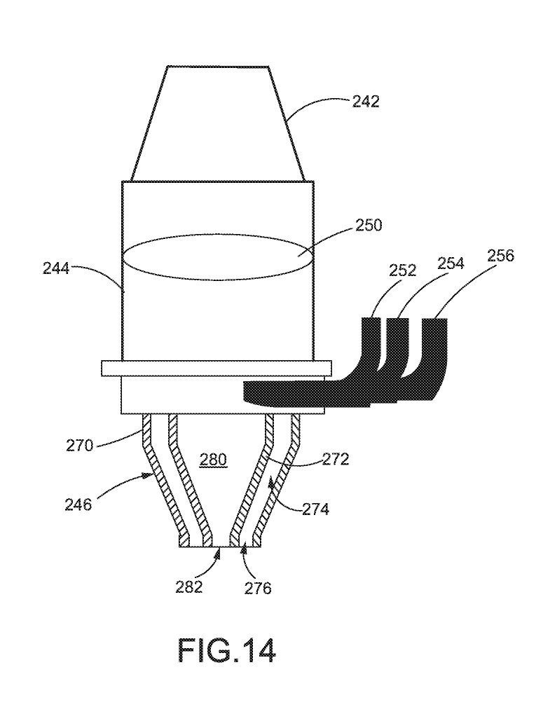

The nozzle 246 may further be configured to permit the fabrication energy beam to pass through the nozzle 246 as it travels toward the target area. As best shown in FIG. 14, the inner nozzle wall 272 defines a central chamber 280 having a fabrication energy outlet 282 aligned with the optic chamber 244 and the optional focusing optic 250. Accordingly, the nozzle 246 permits the beam of fabrication energy to pass through the nozzle 246 to exit the lower processing head 219b.

In an alternative embodiment, an upper processing head 219a′ may have the fabrication energy port 228 provided outside of the housing of the spindle 144 as best shown in FIG. 13. In this embodiment, the fabrication energy port 228 is located on an enclosure 260 provided on a side of the spindle 144, and therefore, unlike the above embodiment, this port is not provided in the socket 232. The enclosure 260 includes a first mirror 262 for directing the fabrication energy toward a point below the socket 232 of the spindle 144. An alternative lower processing head 219b′ includes an optic chamber 244 that includes a fabrication energy receptacle 264 through which the fabrication energy may pass from the enclosure 260 to an interior of the optic chamber 244. The optic chamber 244 further includes a second mirror 266 for redirecting the fabrication energy through the nozzle 246 and toward the desired target location.

With the processing head assembly 219 having the upper processing head 219a configured to selectively couple with any one of several lower processing heads 219b, the computer numerically controlled machine 100 may be quickly and easily reconfigured for different additive manufacturing techniques. The tool magazine 142 may hold a set of lower processing heads 219b, wherein each lower processing head in the set has unique specifications suited for a particular additive manufacturing process. For example, the lower processing heads may have different types of optics, interfaces, and nozzle angles that alter the manner in which material is deposited on the substrate. When a particular part must be formed using different additive manufacturing techniques (or may be formed more quickly and efficiently when multiple different techniques are used), the tool changer 143 may be used to quickly and easily change the particular deposition head coupled to the spindle 144. In the exemplary embodiments illustrated in FIGS. 12 and 13, a single attachment step may be used to connect the energy, feed powder/propellant gas, shield gas, and coolant supplies to the deposition head. Similarly, detachment is accomplished in a single disconnect step. Accordingly, the machine 100 may be more quickly and easily modified for different material deposition techniques.

While FIGS. 12 and 13 illustrate exemplary embodiments of processing head assemblies having lower processing heads that are detachable from upper processing heads, it will be appreciated that such detachability is not essential and therefore other processing head assemblies, such as conventional processing heads that incorporate all of the processing head components into an integral housing, may be used without departing from the scope of the present disclosure.

In additional embodiments, the computer numerically controlled machine 100 may include a material deposition assembly configured to generate a modified energy beam which, when projected on the substrate, forms an energy spot having a non-circular profile, and the machine 100 may control the path direction and rotational orientation of the modified energy beam to produce beads that are more uniformly heated and to more effectively and efficiently produce parts having complex geometries, as discussed in greater detail below.

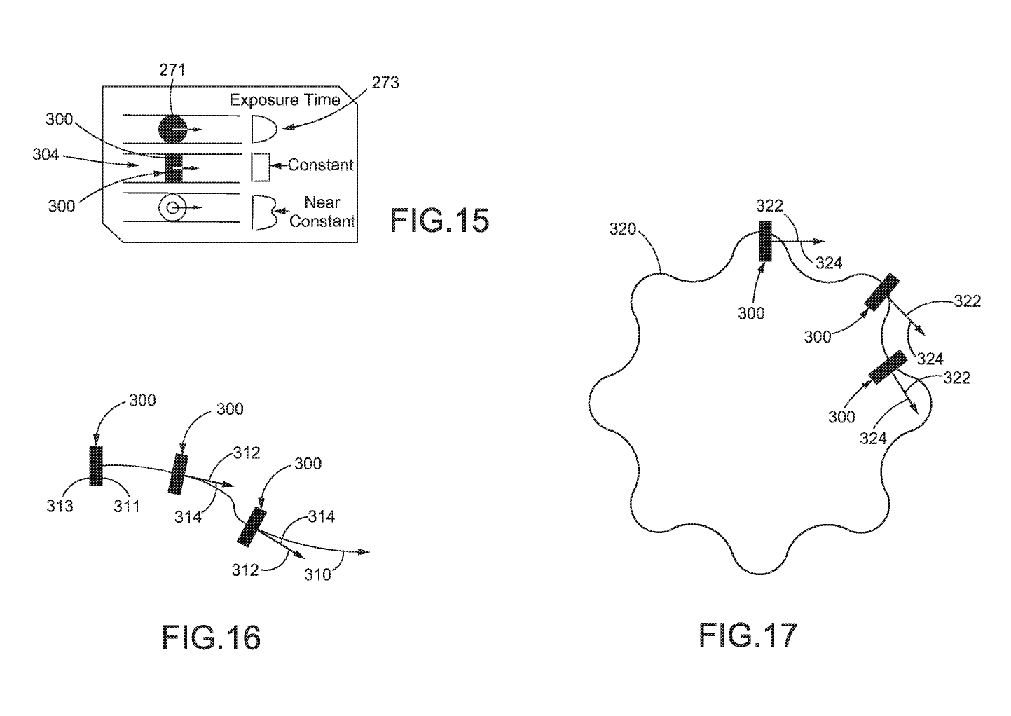

Conventional material deposition processes typically employ energy beams that form energy spots on the substrate having circular profiles 271 (FIG. 15). Thus, rotational orientation of conventional energy beams is irrelevant, as such rotation does not significantly modify the profile of the energy spot formed on the substrate. Additionally, as a circular energy spot traverses a tool path along the substrate, the bead it forms is non-uniformly heated. More specifically, because of the circular profile, the lateral edges of the tool path receive less exposure to the energy beam while the center of the path will receive more exposure to the energy beam, as depicted by the conventional exposure time graphic 273 (FIG. 15). Consequently, the use of conventional energy beams that form energy spots on the substrate with circular profiles may reduce efficiency and limit the part geometries that can be formed.

In view of the foregoing, in some embodiments the computer numerically controlled machine 100 includes a material deposition assembly capable of generating a modified energy beam that has an energy spot with a non-circular profile. In an embodiment schematically illustrated at FIG. 15, the material deposition assembly is configured to generate a modified energy beam that forms an energy spot 300 having a rectangular profile 302. When oriented to extend transversely across a tool path 304, each portion of the tool path 304 will receive a substantially uniform amount of exposure to the energy beam, as depicted by the exposure time graphic 305. In some embodiments, an elliptical profile may be used to approximate a rectangular energy spot profile. An additional embodiment of an energy spot 306 having an annular profile 307 is also schematically illustrated at FIG. 15, and its associated exposure time graphic 308 shows that a near constant level of energy is distributed across a tool path 309. While rectangular and annular profiles are illustrated as examples, it will be appreciated that other perimeter shapes, such as ellipses, squares, other non-circular shapes, may be used.

The spindle 144 may be controlled so that the energy spot 300 maintains a substantially constant angular orientation relative to the tool path. FIG. 16 illustrates a tool path 310 having a non-linear pattern. At each instantaneous point, the tool path 310 defines a tool path vector schematically illustrated by arrows 312 extending at a tangent to the tool path 310 at that point. The orientation of the energy spot 300 may be described with reference to a spot orientation vector 314 extending in an instantaneous direction of travel of the energy spot 300, which in the illustrated embodiment is perpendicular to the leading and trailing edges 311, 313 of the energy spot perimeter. In the embodiment of FIG. 16, the tool path vector 312 and spot orientation vector 314 are substantially coincident to maintain a transversely oriented energy spot 300 along the entire tool path 310.

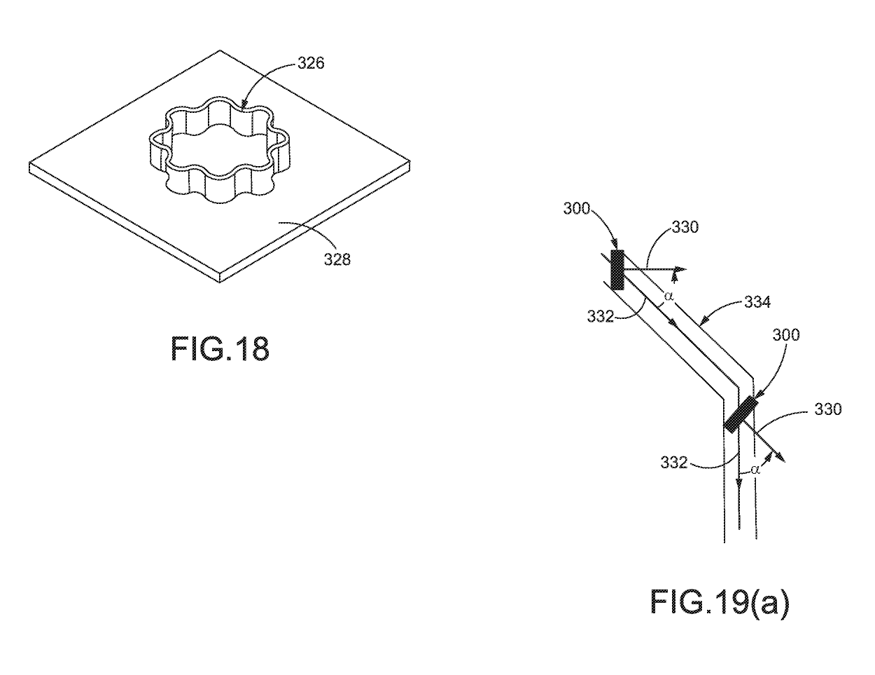

FIG. 17 illustrates a complex tool path 320 that forms a closed pattern layer. As with the tool path shown in FIG. 16, a spot orientation vector 322 of the energy spot 300 is coincident with a tool path vector 324 at all points along the tool path 320. Multiple additional layers may be deposited on top of previously formed layers to generate a three-dimensional part 326 on top of substrate 328, as best shown in FIG. 18.

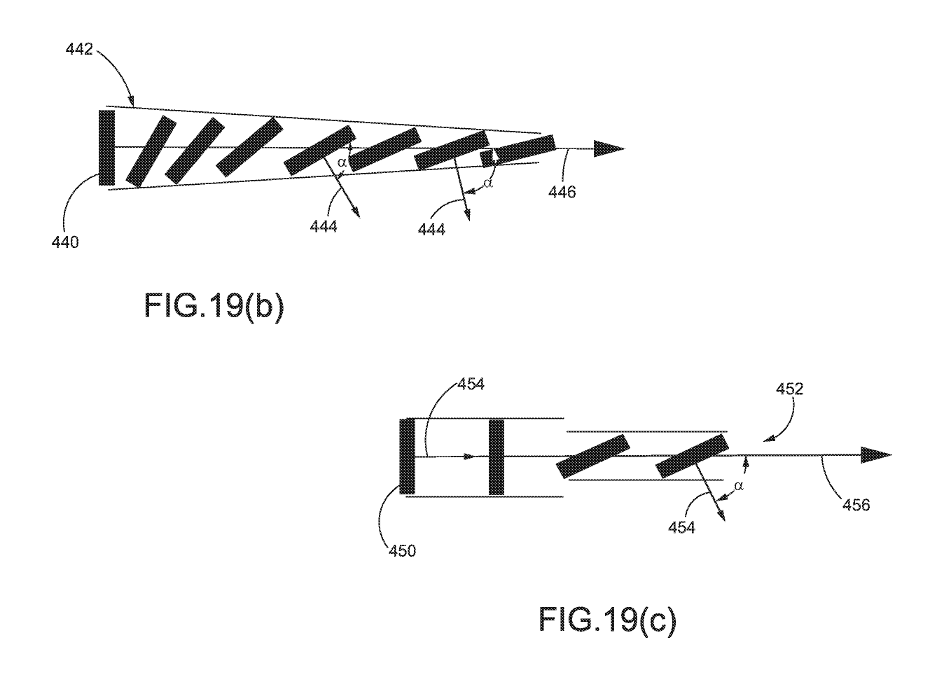

In other alternative embodiments, the energy spot 300 may be configured so that a spot orientation vector 330 is maintained at an angle relative to a tool path vector 332. As illustrated in FIG. 19(a), for example, the spot orientation vector 330 is positioned at a spot angle a relative to the tool path vector 332 as the energy spot 300 travels along a tool path 334. With this orientation, the extreme lateral edges of the tool path 334 will receive less energy beam exposure time while the middle portion of the tool path 334 will receive substantially uniform energy beam exposure time. The spot angle a may be maintained substantially constant along the entire tool path 334 to form a uniform bead width.

Alternatively, as shown in FIGS. 19(b) and 19(c), the spot angle a may be varied as it travels along the tool path to form a bead having a varied width. FIG. 19(b) illustrates an energy spot 440 traversing a straight tool path 442. A spot orientation vector 444 of the energy spot 440 extends at a spot angle a relative to a tool path vector 446. As illustrated in FIG. 19(b), the spot angle a gradually increases as the energy spot 440 travels down the tool path 442.

Alternatively, the spot angle may undergo a step change rather than a gradual change. As illustrated in FIG. 19(c), an energy spot 450 may traverse a straight tool path 452. A spot orientation vector 454 of the energy spot 450 is oriented along a spot angle a relative to a tool path vector 456. At an intermediate point along the tool path 452, the spot angle a is abruptly changed to narrow a width of the path traversed by the energy spot 450.

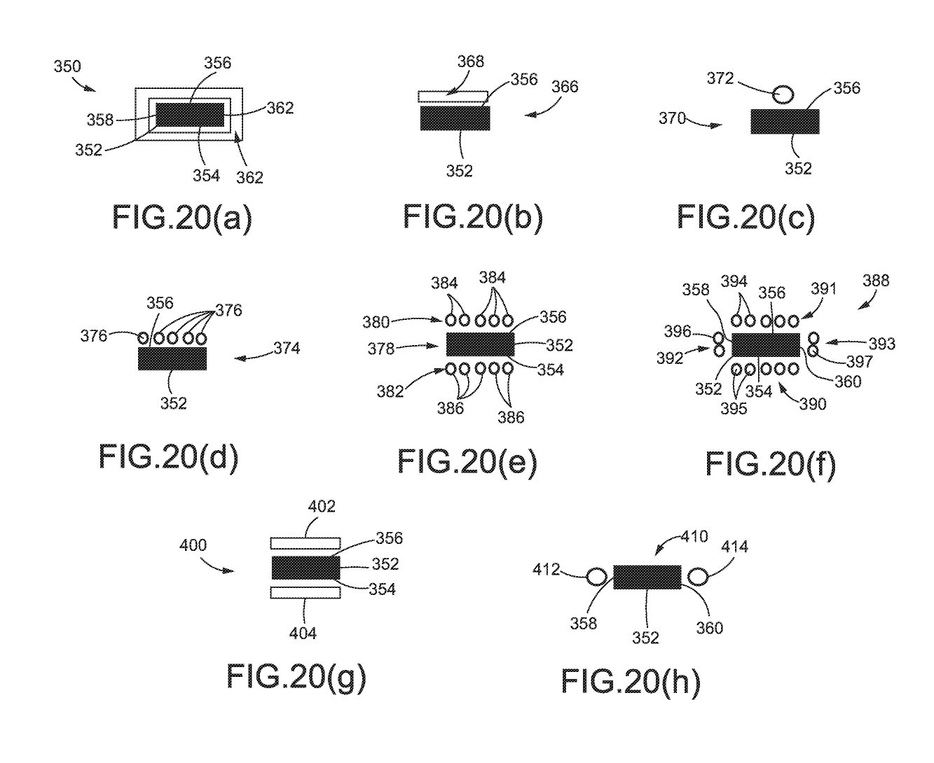

In each of the above embodiments, the perimeter shape of the energy spot may correspond to a shape of the fabrication energy outlet. For example, a fabrication energy outlet having a rectangular shape will produce an energy beam having a rectangular perimeter. FIGS. 20(a)-(h) schematically illustrate alternative embodiments of nozzles having rectangular-shaped fabrication energy outlets with different configurations of nozzle exits.

More specifically, FIG. 20(a) illustrates a nozzle 350 having a fabrication energy outlet 352 with a rectangular shape defining opposed leading and trailing edges 354, 356 and opposed first and second side edges 358, 360. A nozzle exit orifice 362 extends continuously around the perimeter of the fabrication energy outlet 352 and also has a rectangular shape.

FIG. 20(b) illustrates a nozzle 366 having the same fabrication energy outlet 352 as above, but with a nozzle exit orifice 368 positioned outside of the fabrication energy outlet 352 and adjacent the trailing edge 356. The nozzle exit orifice 368 has a rectangular shape.

FIG. 20(c) illustrates a nozzle 370 having the fabrication energy outlet 352, but with a nozzle exit orifice 372 positioned outside of and adjacent to the trailing edge 356, and having a circular shape.

FIG. 20(d) illustrates a nozzle 374 with the same fabrication energy outlet 352, but with a nozzle exit comprising a plurality of nozzle exit orifices 376 having circular shapes and positioned adjacent to the trailing edge 356.

FIG. 20(e) illustrates a nozzle 378 with the fabrication energy outlet 352, but with a first nozzle exit 380 and a second nozzle exit 382. The first nozzle exit 380 includes a first set of nozzle exit orifices 384 having circular shapes and positioned adjacent the trailing edge 356, while the second nozzle exit 382 includes a second set of nozzle exit orifices 386 having circular shapes and positioned adjacent the leading edge 354.

FIG. 20(f) illustrates a nozzle 388 having the fabrication energy outlet 352, but with first, second, third, and fourth nozzle exits 390, 391, 392, and 393. The first nozzle exit 390 includes a first set of nozzle exit orifices 394 having circular shapes and positioned adjacent the trailing edge 356. The second nozzle exit 391 includes a second set of nozzle exit orifices 395 having circular shapes and positioned adjacent a leading edge 354. The third nozzle exit 392 includes a third set of nozzle exit orifices 396 having circular shapes and positioned adjacent the first side edge 358. Finally, the fourth nozzle exit 393 includes a fourth set of nozzle exit orifices 397 having circular shapes and positioned adjacent the second side edge 360 of the fabrication energy outlet 352.

FIG. 20(g) illustrates a nozzle 400 having the same fabrication energy outlet 352, but with a first nozzle exit orifice 402 having a rectangular shape and positioned adjacent the trailing edge 356, and a second nozzle exit orifice 404 having a rectangular shape and positioned adjacent the leading edge 354.

Finally, FIG. 20(h) illustrates a nozzle 410 having the fabrication energy outlet 352, but with a first nozzle exit orifice 412 having a circular shape and positioned adjacent the first side edge 358, and a second exit orifice 414 having a circular shape and positioned adjacent the second side edge 360.

In the additive manufacturing processes described above, the feed powder/propellant gas is typically directed toward the center of the focal point of the energy beam. For example, in the embodiment illustrated at FIG. 11, the apex 215 of the feed powder/propellant gas coincides with a focal point 217 of the concentrated energy beam 208. According to certain aspects of the present disclosure, however, it may be advantageous to direct the feed powder/propellant gas not at the center of the focal point 217 but instead at a target offset from the focal point of the energy beam as it traverses the substrate.

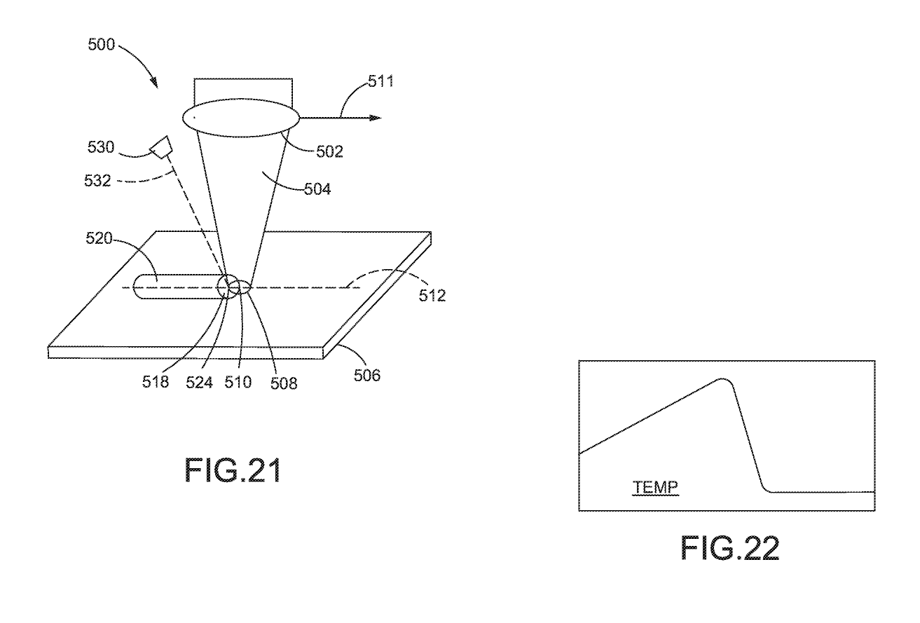

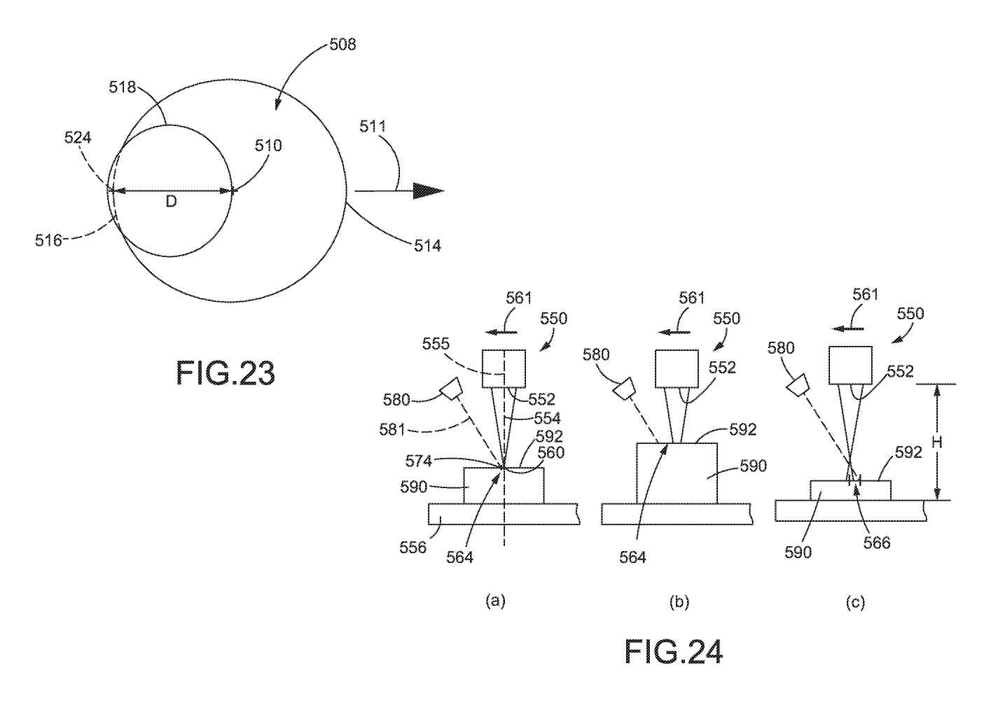

In some applications, the feed powder/propellant gas may be directed at a trailing edge of the energy beam to more efficiently incorporate the feed powder into the built surface. In the exemplary embodiment illustrated at FIG. 21-23, a processing head 500 includes a fabrication energy outlet 502 operably coupled to a source of fabrication energy and through which an energy beam 504 is projected toward a substrate 506. The energy beam 504 forms an energy spot 508 on the substrate 506 that is centered about a beam target 510. As the processing head 500 moves in a direction 511, the energy spot traverses the substrate 506 along a tool path 512. Based on the direction 511 of travel, the energy spot 508 will have a leading edge 514 and a trailing edge 516, as best shown in FIG. 23.

As the energy spot 508 passes over a given location on the substrate 506, the temperature of that location on the substrate 506 quickly increases and then gradually decreases, as schematically illustrated in FIG. 22. While the temperature remains elevated above a melting point of the substrate material, it forms a melt pool 518 capable of incorporating feed powder to build a layer 520 of material on top of the substrate 506. A given point on the substrate 506 may be exposed to the energy spot 508 for a given period of time before it forms the melt pool 518. As shown in FIGS. 21 and 23, for example, the melt pool 518 will typically form at the trailing edge 516 of the energy spot 508. The trailing edge 516 is defined as the edge of the energy spot 508 that is opposite the direction 511 of travel.

The processing head 500 further includes a nozzle 530 operably coupled to a source of feed powder/propellant gas and oriented to direct a jet 532 of feed powder/propellant gas toward a powder target 524 on the substrate 506. The powder target 524 is spaced from the beam target 510 by an offset distance “D.” More specifically, the powder target 524 may be coincident with the trailing edge 516 of the energy spot 508 so that a greater percentage of feed powder is incorporated into the melt pool 518. The orientation of the processing head 500 may be controlled to maintain the offset distance “D” between the powder target 524 and the beam target or beam target 510. For example, the orientation of the processing head 500 may be controlled so that the powder target 524 remains coincident with the trailing edge 516 as the energy spot 508 traverses the tool path 512.

In still other alternative embodiments, the feed powder/propellant gas may be directed at a leading edge of the energy beam, which may automatically correct errors in built structure height. In the exemplary embodiment illustrated at FIG. 24, a processing head 550 includes a fabrication energy outlet 552 operably coupled to a source of fabrication energy and through which an energy beam 554 is projected toward a substrate 556 along a beam axis 555. The energy beam 554 forms an energy spot at a beam target 560. As the processing head 550 moves in a direction 561, the energy spot traverses the substrate 556 along a tool path. Based on the direction 561 of travel, the energy spot 558 will have a leading edge 564.

The processing head 550 further includes a nozzle 580 operably coupled to a source of feed powder/propellant gas and oriented to direct a jet of feed powder/propellant gas along a powder axis 581 and toward a powder target 574 on the substrate 556. The powder axis 581 may extend at an angle relative to the beam axis 555. The powder target 574 is spaced from the beam target 560 by an offset distance. More specifically, under normal conditions the powder target 574 may be coincident with the leading edge 564 of the energy spot. The orientation of the processing head 550 may be controlled so that the powder target 574 remains coincident with the leading edge 564 as the energy spot 558 traverses the tool path 512

The processing head 550 may be maintained at a command height “H” relative to the substrate 556. When the processing head generates a desired thickness of the built structure 590, as illustrated at FIG. 24(a), a normal distance is provided between the processing head 550 and the structure surface 592, so that the feed powder/propellant gas is directed toward the leading edge 564 of the energy spot.

Should operational or other errors during deposition of previous layers cause the built structure 590 to be too thick, as illustrated at FIG. 24(b), a decreased distance is provided between the processing head 550 and the structure surface 592, which causes the feed powder/propellant gas to be directed ahead of the leading edge 564 of the energy spot. When this condition exists, less feed powder reaches the melt pool, thereby reducing the thickness of the layer currently being added to the built structure 590 and counteracting at least a portion of the overly large thickness deposited in previous layers of the structure 590.

Alternatively, should operational or other errors during deposition of previous layers cause the built structure 590 to be too thin, as illustrated at FIG. 24(c), an increased distance is provided between the processing head 550 and the structure surface 592, which cause the feed powder/propellant gas to be directed toward a trailing edge 566 of the energy spot. Under these conditions, more feed powder reaches the melt pool, thereby increasing the thickness of the layer currently being added to the built structure 590 and counteracting at least a portion of the overly small thickness deposited in previous layers of the structure. Accordingly, when the processing head 550 is maintained at the command height “H,” by directing the feed powder/propellant toward the leading edge of the energy spot the additive process will automatically self-correct errors in the thickness of previously deposited layers of material.

As supplied, the apparatus may or may not be provided with a tool or workpiece. An apparatus that is configured to receive a tool and workpiece is deemed to fall within the purview of the claims recited herein. Additionally, an apparatus that has been provided with both a tool and workpiece is deemed to fall within the purview of the appended claims. Except as may be otherwise claimed, the claims are not deemed to be limited to any tool depicted herein.

All references, including publications, patent applications, and patents, cited herein are hereby incorporated by reference. The description of certain embodiments as “preferred” embodiments, and other recitation of embodiments, features, or ranges as being preferred, is not deemed to be limiting, and the claims are deemed to encompass embodiments that may presently be considered to be less preferred. All methods described herein can be performed in any suitable order unless otherwise indicated herein or otherwise clearly contradicted by context. The use of any and all examples, or exemplary language (e.g., “such as”) provided herein, is intended to illuminate the disclosed subject matter and does not pose a limitation on the scope of the claims. Any statement herein as to the nature or benefits of the exemplary embodiments is not intended to be limiting, and the appended claims should not be deemed to be limited by such statements. More generally, no language in the specification should be construed as indicating any non-claimed element as being essential to the practice of the claimed subject matter. The scope of the claims includes all modifications and equivalents of the subject matter recited therein as permitted by applicable law. Moreover, any combination of the above-described elements in all possible variations thereof is encompassed by the claims unless otherwise indicated herein or otherwise clearly contradicted by context. The description herein of any reference or patent, even if identified as “prior,” is not intended to constitute a concession that such reference or patent is available as prior art against the present disclosure.

What is claimed is:

1. A method of depositing material on a substrate using a machine tool for use with a fabrication energy supply and a feed powder/propellant supply, the method comprising:
securing a substrate in a first tool holder;
securing a processing head assembly in a second tool holder, the processing head assembly including a nozzle defining a fabrication energy outlet operably coupled to the fabrication energy supply and having a non-circular shape, and a nozzle exit operably coupled to the feed powder/propellant supply;
projecting a fabrication energy beam from the fabrication energy outlet onto the substrate to form an energy spot at a target area of the substrate, a profile of the energy spot having a non-circular shape corresponding to the non-circular shape of the fabrication energy outlet;
projecting feed powder/propellant from the nozzle exit onto the target area of the substrate;
causing relative movement between the first and second tool holders so that the energy spot traverses a tool path along the substrate, wherein movement of the energy spot defines a spot orientation vector extending in an instantaneous direction of travel of the energy spot, and wherein the tool path defines a tool path vector extending at a tangent to the tool path; and
controlling an orientation of the second tool holder based on an orientation of the spot orientation vector relative to the tool path vector.

2. The method of claim 1, in which controlling the orientation of the second tool holder comprises orienting the second tool holder so that the spot orientation vector extends at a spot angle relative to the tool path vector.

3. The method of claim 2, in which the spot angle is zero.

4. The method of claim 2, in which the spot angle is greater than zero.

5. The method of claim 2, in which the spot angle is constant along the tool path.

6. The method of claim 2, in which the spot angle varies along the tool path.

7. A machine tool for use with a feed powder/propellant supply and a fabrication energy supply, the machine tool comprising:
a first tool holder carrying a substrate;
a second tool holder;
a processing head assembly coupled to the second tool holder and including:
a feed powder/propellant interface operably coupled to the feed powder/propellant supply;
a fabrication energy interface operably coupled to the fabrication energy supply;
a fabrication energy outlet operably coupled to the fabrication energy interface, the fabrication energy outlet having a non-circular shape; and
a nozzle defining a nozzle exit fluidly communicating with the feed powder/propellant interface;
machine control circuitry operatively coupled to the first tool holder and the second tool holder, the machine control circuitry comprising one or more central processing units and one or more memory devices, the one or more memory devices storing instructions that, when executed by the one or more central processing units, cause the machine control circuitry to:
position the first and second tool holders to direct a fabrication energy beam from the fabrication energy outlet onto the substrate to form an energy spot at a target area of the substrate, the energy spot having a profile that is non-circular, and to direct feed powder/propellant from the nozzle exit onto the target area of the substrate;
cause relative movement between the first and second tool holders so that the energy spot traverses a tool path along the substrate, wherein movement of the energy spot defines a spot orientation vector extending in an instantaneous direction of travel of the energy spot, and wherein the tool path defines a tool path vector extending at a tangent to the tool path; and
control an orientation of the second tool holder based on an orientation of the spot orientation vector relative to the tool path vector.

8. The machine tool of claim 7, in which the instructions further cause the machine control circuitry to orient the second tool holder so that the spot orientation vector extends at a spot angle relative to the tool path vector.

9. The machine tool of claim 8, in which the instructions further cause the machine control circuitry to maintain the spot angle at zero degrees.

10. The machine tool of claim 8, in which the instructions further cause the machine control circuitry to maintain the spot angle at greater than zero degrees.

11. The machine tool of claim 8, in which the instructions further cause the machine control circuitry to maintain the spot angle at a constant value along the tool path.

12. The machine tool of claim 8, in which the instructions further cause the machine control circuitry to vary the spot angle along the tool path.

13. A method of depositing material on a substrate using a machine tool for use with a fabrication energy supply and a feed powder/propellant supply, the method comprising:
securing a substrate in a first tool holder;
securing a processing head assembly in a second tool holder, the processing head assembly including a nozzle defining a fabrication energy outlet operably coupled to the fabrication energy supply, and a nozzle exit operably coupled to the feed powder/propellant supply;
projecting a fabrication energy beam from the fabrication energy outlet onto the substrate to form an energy spot at a beam target on the substrate;
projecting feed powder/propellant from the nozzle exit toward a powder target on the substrate, wherein the powder target is spaced by an offset distance from the beam target;
causing relative movement between the first and second tool holders so that the energy spot traverses in a travel direction along a tool path across the substrate; and
controlling an orientation of the second tool holder to maintain the offset distance between the beam target and the powder target as the energy spot traverses the tool path.

14. The method of claim 13, in which the energy spot defines a trailing edge relative to the travel direction, and in which the powder target is coincident with the trailing edge of the energy spot.

15. The method of claim 13, in which the energy spot defines a leading edge relative to the travel direction, and in which the powder target is coincident with the leading edge of the energy spot.

16. The method of claim 15, in which the energy target is disposed along a beam axis, and the powder target is disposed along a powder axis extending at an angle to the beam axis.

17. A machine tool for use with a feed powder/propellant supply and a fabrication energy supply, the machine tool comprising:
a first tool holder carrying a substrate;
a second tool holder;
a processing head assembly coupled to the second tool holder and including:
a feed powder/propellant interface operably coupled to the feed powder/propellant supply;
a fabrication energy interface operably coupled to the fabrication energy supply;
a fabrication energy outlet operably coupled to the fabrication energy interface; and
a nozzle defining a nozzle exit fluidly communicating with the feed powder/propellant interface;
machine control circuitry operatively coupled to the first tool holder and the second tool holder, the machine control circuitry comprising one or more central processing units and one or more memory devices, the one or more memory devices storing instructions that, when executed by the one or more central processing units, cause the machine control circuitry to:
position the first and second tool holders to direct a fabrication energy beam from the fabrication energy outlet onto the substrate to form an energy spot at a beam target on the substrate, and to direct feed powder/propellant from the nozzle exit toward a powder target on the substrate, wherein the powder target is spaced by an offset distance from the beam target;
cause relative movement between the first and second tool holders so that the energy spot traverses a tool path in a travel direction across the substrate; and
control an orientation of the second tool holder to maintain the offset distance between the beam target and the powder target as the energy spot traverses the tool path.

18. The machine tool of claim 17, in which the energy spot defines a trailing edge relative to the travel direction, and in which the powder target is coincident with the trailing edge of the energy spot.

19. The machine tool of claim 17, in which the energy spot defines a leading edge relative to the travel direction, and in which the powder target is coincident with the leading edge of the energy spot.

20. The machine tool of claim 19, in which the energy target is disposed along a beam axis, and the powder target is disposed along a powder axis extending at an angle to the beam axis.
